(19) United States
(12) Patent Application Publication
(10) Pub. No.: US 2017/0002158 A1
(43) Pub. Date: Jan. 5, 2017

(54) SURFACE AND COMPOSITION

(71) Applicant: DUPONT NUTRITION BIOSCIENCES APS, Copenhagen K (DK)

(72) Inventors: Hans Peter HENTZE, Tilst (DK); Bjarne NIELSEN, Silkeborg (DK); Pouel ANDERSEN, Horning (DK)

(21) Appl. No.: 15/106,895

(22) PCT Filed: Dec. 19, 2014
(86) PCT No.: PCT/EP2014/078670

§ 371 Date: Jun. 21, 2016

(30) Foreign Application Priority Data
Dec. 23, 2013 (GB) 1322892.9

(51) Int. Cl. C08J 7/06; B65D 85/72; B65D 23/02; C09D 5/02

(52) U.S. Cl. CPC C08J 7/065; C09D 5/022; B65D 85/72; B65D 23/02; C08J 2367/00

(57) ABSTRACT

This invention describes a polymer surface being coated at least partly with a coating composition comprising at least one oil and at least one emulsifier, which forms a homogenous solution. The invention further describes a container for holding a fluid comprising at least one inner surface, said inner surface being, in use, in contact with said fluid where said inner surface is a coated surface. The invention further describes a use of a coating composition for improvement of release properties of a polymer surface by coating at least partly said surface with said coating composition comprising at least one oil and at least one emulsifier, which forms a homogenous solution.

### FIELD OF THE INVENTION

This invention relates to a coating composition for at least partly coating a polymer surface. The surface can be an inner surface facing a cavity in a container, which may hold a fluid. The coating composition enables improved release of the fluid from the container.

### BACKGROUND OF THE INVENTION

Consumer products with relatively high viscosity are often stored in containers such as flasks, cartons and tubes. Examples of these products are food products such as mayonnaise and concentrated and non-concentrated fermented products like yogurt, fromage frais, and Ymer (a concentrated mesophilic product) as well as non-food products like toothpaste, creams and sun lotion. Due to their relatively high viscosity a considerably high amount of product adheres to the sides of the container and is not easily removed here from. Thus, the consumer is not able to get the entire product out of the container. This is not only a waste of money but also a waste of resources.

The adherence of the viscous product to the sides of the container is due to the nature of the product. One solution to this problem is for example to re-design the shape of the container in order to remove corners and angles in which the viscous product could get caught. Another solution is to coat the surfaces of the container in order to reduce the surface tension between the product and the container, hereby reducing the adherence of the product to the sides of the container.

EP1992567 describes a container that has improved release properties for a viscous material where the container is configured to minimize residual material remaining in the container upon normal use thereof and also generally maintains the physical stability of material in the container. The container includes a coating applied to a portion of the inner surfaces thereof that is effective to provide the improved release properties. The document describes a coating, which is a lipid composition comprising glycerol esters having about 70 to about 100 percent fatty acid residues between 6 and 12 carbon atoms inclusive; and/or is a vegetable oil comprising a soluble antioxidant selected from the group consisting of TBHQ, BHT, BHA, gallates, tocopherols, tocotrienols, ascorbyl palmiate, and mixtures thereof. The document also describes how coatings with low viscosity such as pure oils show improved release properties.

U.S. Pat. No. 6,247,603 describes a dispensing apparatus and method for increasing product removal utilizing a coating. The apparatus includes a container having an outlet, a wall and a chamber. The chamber houses the coating and a product. The coating substantially covers the container wall. The product is dispensed through the container outlet without substantially removing all the coating applied to the container wall. The coating is a natural oil such as soybean oil, olive oil or a mineral oil.

Alternatively, other changes have been made to the container in order to increase the release properties such as including an additive into the material of the container in order to change the surface properties of the sides of the container and hereby increase the release properties.

US2003215555 describes food containers with increased release characteristics. More specifically, plastic food containers containing glycerol monostearate at a level of greater than about 4000 ppm, and preferably at levels of about 6000 to about 8000 ppm are provided. The glycerol monostearate apparently acts as a release agent to allow food products to be dispensed more easily. For example, cream cheese provided in the food containers of this invention can be dispensed in a single block which would be especially useful for recipe use.

US2007179230 describes how to prevent packaging materials made of thermoplastic polymers from adhering to pasty and fatty foods. A nonstick composition comprising a fatty acid ester of a polyhydric alcohol having at least one fatty acid radical per ester molecule with 19 or more carbon atoms is incorporated into at least one selected area of a polymer packaging material. Even if included only in surface-close regions or layers of the packaging material, a permanent nonstick effect is observed. This document thus does not describe the coating of a surface in order to improve the release properties of the surface.

Thus, multiple solutions exist in order to try to reduce the amount of residual product in the form of a fluid to be left in the containers. However, alternative solutions are still needed for reducing the amount of fluid left in the containers.

### OBJECT OF THE INVENTION

It is the object of the invention to provide a coating composition and a surface coated at least partly with the coating composition to obtain improved release of a fluid from the surface as compared to a non-coated surface.

### DETAILED DESCRIPTION

This objective can be achieved by a coating composition for coating a polymer surface consisting of an oil and an emulsifier, which forms a substantially homogenous solution. Hereby, is obtained a coating composition with excellent release properties. This means that less fluid is retained on a surface when draining the fluid from the surface in the case where the surface is coated with the coating composition as compared to the case where the surface is not coated.

By substantially homogenous solution is to be understood that the coating composition comprises substantially only one phase. Thus, a homogenous solution is a mixture of two or more components having a uniform appearance and composition.

Adding an emulsifier to the coating composition highly increases the release properties of the coating composition as compared to having the oil alone as can be seen from the examples.

In a further embodiment, said emulsifier is a glycerol or polyglycerol ester. In a still further embodiment, said emulsifier is selected from diglycerol esters, polyglycerol fatty acid esters (PGEs), citric acid ester of mono-diglycerides (CITREM) or diacetyl tartaric ester of mono-diglycerides (DATEM). In another embodiment, said emulsifier is a monoglyceride or a mono-diglyceride of fatty acid esters.

Alternatively, the emulsifier is GRINDSTED® PGE, GRINDSTED® CITREM or GRINDSTED® DATEM.

In a further embodiment, the HLB-value of the emulsifier is above 3, like above 4, such as above 4.5, like above 5. In a still further embodiment, the HLB-value is in the range of around 7 to around 12. In a further embodiment, the HLB-value is above 2, such as above 2.5.

The higher the HLB of the emulsifier, the more hydrophilic it is. The HLB value describes the ratio of hydrophilic and lipophilic entities per molecule. According to the HLB method by Griffin and Davies (W. C. Griffin “Classification of Surface-Active Agents by ‘HLB”’, Journal of the Society of Cosmetic Chemists 1 (5): 311-26 (1949)), it is ranked on a scale from 0 to 20. A HLB value of 1 refers to a very lipophilic substance. Compounds with an HLB value of 20 are very hydrophilic. Pure lipids with no emulsifying properties, like medium chain lengths triglycerides (MCT), have a HLB value of 0 (H. N. Prajapati et al. “A Comparative Evaluation of Mono-, Di- and Triglyceride of Medium Chain Fatty Acids by Lipid/Surfactant/Water Phase Diagram, Solubility Determination and Dispersion Testing for Application in Pharmaceutical Dosage Form Development”, Pharm Res 29(1), pp 285-305 (2012)). The HLB value of glycerol esters is defined as HLB=20*(1−S/A), with S as the saponification value of the ester and A as the acid value of the fatty acid used for the esterification.

The HLB values as defined in this description are according to the method of Griffin and Davis.

In a further embodiment, said oil is a vegetable oil. This would mean that the oil is an edible oil and that the coating composition containing this type of oil can be used for release of food products.

In a still further embodiment, said oil is rapeseed oil, soybean oil, high oleic sunflower oil or a mixture of one or more hereof. Hereby, it is to be understood that the term oil covers not only one type of oil but may be two, three, four, five etc. oils which are mixed to form the final oil of the coating composition.

Other examples of oils could be synthetic or natural triglycerides, such as high oleic soybean oil, sunflower oil, peanut oil, cottonseed oil, palm oil, olive oil or coconut oil, as well as fish oil, babassu oil or palmkernel oil.

Alternatively, the oil is not a vegetable oil but a natural or synthetic mineral oil such as paraffinic oils, naphthenic oils and aromatic oils, for example mixtures of liquid alkanes, petroleum, cyclohexane, toluene, essential oils or polyether.

In a further embodiment, said emulsifier is present in an amount of 0.1-50 wt % of the coating. In a further embodiment, said emulsifier is present in an amount of 0.1-10 wt % of the coating. In a further embodiment, said emulsifier is present in an amount of 0.3-8 wt % of the coating. In a further embodiment, said emulsifier is present in an amount of 0.5-5 wt % of the coating.

In a further embodiment, a polymer surface being coated at least partly with a coating composition as described above is described. Hereby, it is to be understood that the coating composition as described herein is applied to a surface whereby the properties of the surface is modified. Thus, the release properties of the surface are changed. The coating composition is applied as described elsewhere herein.

This surface is a polymer surface. In a further embodiment, the surface is made from a composite material, a mixture of different materials for example a mixture of a polymer and glass fibers.

This invention further describes a polymer surface being coated at least partly with a coating composition comprising at least one oil and at least one emulsifier, which forms a homogenous solution.

It is to be understood that “at least partly” means that when the surface is coated with the coating composition the coating composition need not cover the entire surface. In some embodiments, the whole surface will be covered by the coating composition while in other embodiments, only a part of the surface is coated, for example 95% of the surface, 75% of the surface, 50% of the surface, 25% of the surface or 5% of the surface. The part of the surface coated by the coating composition is not limited to these examples.

Furthermore, it is to be understood that if the polymer surface is only partly coated with the coating composition it need not be coated in one selected area, but can be coated in multiple selected areas.

In one embodiment, the non-coated parts of the polymer surface may comprise negligible or trace amounts of the coating composition.

It has been found that applying coating solutions of at least one emulsifier and oils on polymer surfaces results in highly improved fluid release properties. The effect can be seen for different types of emulsifiers, such as glycerol and polyglycerol esters, and various oils.

In one embodiment, the coating is applied in an amount of 0.10 mg/cm²-1.30 mg/cm². In a further embodiment, the coating is applied in an amount of 0.30 mg/cm²-0.85 mg/cm².

By “at least one emulsifier” is to be understood that the coating composition can comprise one, two, three, four, five etc. different emulsifiers mixed in the coating composition.

By “at least one oil” is to be understood that the coating composition can comprise one, two, three, four, five etc. different types of oils mixed in the coating composition.

The polymer surface is coated with the coating composition by applying the coating composition to the surface. This can be performed by methods such as dip-coating or spray-coating but other methods known by the skilled person in the art can be used as well.

In one embodiment, the viscosity of the coating composition at 25° C. is between 10 cP and 3,000 cP. In a further embodiment, the viscosity of the coating composition at 25° C. is between 20 cP and 1000 cP. In a still further embodiment, the viscosity of the coating composition at 25° C. is between 30 and 500 cP. In a still further embodiment, the viscosity of the coating composition at 25° C. is between 50 cP and 500 cP. In a still further embodiment, the viscosity of the coating composition at 25° C. is between 50 cP and 100 cP.

In a further embodiment, said at least one emulsifier is a glycerol or polyglycerol ester. In a still further embodiment, said at least one emulsifier is selected from diglycerol esters, polyglycerol fatty acid esters (PGEs), citric acid ester of mono-diglycerides (CITREM), diacetyl tartaric ester of mono-diglycerides (DATEM) or a mixture of one or more hereof. In another embodiment, said at least one emulsifier is a monoglyceride or a mono-diglyceride of fatty acid esters.

Alternatively, said at least one emulsifier is esters of sorbitol, esters of sorbitan, esters of propanediol, amphiphilic polymers, ionic or non-ionic surfactants. Examples of suitable PGEs are GRINDSTED® PGE 308 and GRINDSTED® PGE 0 80.

In a further embodiment, the HLB-value of the emulsifier is above 3, like above 4, such as above 4.5, like above 5. In a still further embodiment, the HLB-value is in the range of around 7 to around 12. In a further embodiment, the HLB-value is above 2, such as above 2.5.

In a further embodiment, said oil is a vegetable oil. In a still further embodiment, said oil is rapeseed oil, soybean oil, high oleic sunflower oil or a mixture of one or more hereof. Hereby, it is to be understood that the term ‘oil’ covers not only one type of oil but may be two, three, four, five etc. oils which are mixed to form the final oil of the coating composition.

Other examples of oils could be synthetic or natural triglycerides, such as high oleic soybean oil, sunflower oil, peanut oil, cottonseed oil, palm oil, olive oil or coconut oil, as well as fish oil, babassu oil or palmkernel oil.

Alternatively, the oil is not a vegetable oil but a natural or synthetic mineral oil such as paraffinic oils, naphthenic oils and aromatic oils, for example mixtures of liquid alkanes, petroleum, cyclohexane, toluene, essential oils or polyether.

Applying the at least one emulsifier in combination with the oil improves or enables the wettability of the surface. Thus, oils, which have a hydrophobicity that does not allow homogeneous wetting of the surface without at least one emulsifier are also applicable.

In one embodiment, said at least one emulsifier is present in an amount of 0.1-50 wt % of the coating. In a further embodiment, said at least one emulsifier is present in an amount of 0.1-10 wt % of the coating. In a further embodiment, said at least one emulsifier is present in an amount of 0.3-8 wt % of the coating. In a still further embodiment, said at least one emulsifier is present in an amount of 0.5-5 wt % of the coating.

Different polymers can be used such as polyesters and polyolefins. Alternatively, other polymers such as thermoplastic, elastomeric, duroplastic polymers and thermoplastic elastomers can be used for the surface.

In a further embodiment, said polymer is polypropylene (PP) or polyethylene terephthalate (PET).

In a still further embodiment, said polymer is cellulose, natural fibers, cardboard or the like.

Hence, any polymer or plastic can be used, for instance polyolefins, polyvinyl chloride, polyesters, ionomers and polycarbohydrates. Besides synthetic polymers natural polymers and fibers, like polypeptides, celluloses or lignocellulosic materials, e.g. paper and cardboard can also be used.

In a further embodiment, said surface is part of a structure, said structure comprises an internal additive.

It is to be understood that the structure can be any type of object independent of the shape or form of the object as long as the structure comprises at least one surface onto which the coating composition can be applied.

The internal additive is incorporated into the structure during production hereof. The internal additive is capable of migrating from inside the structure to the surface of the structure. This changes the surface properties and thus, the release properties of the surface. The release properties of the surface can hence be changed both by the internal additive and the coating composition.

In a further embodiment, the internal additive is a distilled monoglyceride, a mono-diglyceride, a diglycerol ester or a mixture of one or more hereof.

In a further embodiment, said internal additive constitute between 0.1 and 5 wt % of said structure. In a further embodiment, said internal additive constitute between 0.2 and 3 wt % of said structure. In a further embodiment, said internal additive constitute between 0.3 and 2 wt % of said structure. In a further embodiment, said internal additive constitute 0.5-1.5 wt % of said structure.

This invention further describes a polymer surface, where the surface is part of a structure and the structure comprises an internal additive and where said surface further is coated at least partly with a coating composition, where the coating composition comprises at least one oil.

This invention further describes a container for holding a fluid comprising at least one inner surface, said inner surface being, in use, in contact with said fluid where said inner surface is a surface as described herein. Where “in use” is to be understood as when the fluid is contained in the container.

The container can be any means which are capable of containing a fluid such as a flask, a bucket, a can, a jar, a bottle, a trough, a carton, a tube etc.

The container may have more inner surfaces depending on the type of container. By “inner surface” is to be understood a surface which comes into contact with the fluid when the fluid is contained in the container. The fluid need not be in contact with the entire inner surface or the entire inner surfaces but may be in contact with only a part hereof depending on how much fluid is in the container.

In one embodiment, the container comprises an outlet opening and a cavity, said outlet opening connects said cavity with the outside. The container is filled with the fluid and exits the container via the outlet opening. The cavity is surrounded by surfaces, which are at least partly coated with a coating composition as described elsewhere in the description.

When the fluid exits the container the coating composition helps the release of the fluid from the inner surface(s) of the container whereby less fluid adheres to the surface(s) and is retained in the container.

In one embodiment, said fluid is a food product. In a further embodiment, said food product is mayonnaise or concentrated and non-concentrated fermented products.

Concentrated and non-concentrated fermented products are products such as but not limited to yogurt and Ymer (a concentrated mesophilic product).

Examples of other products include but are not limited to mustard, ketchup, salad dressings, sandwich spreads, sauces, marinades, pastes, jams, honey, liquid margarine, liquid cheese and syrups.

In another embodiment, said fluid is a non-food product. In a further embodiment, said non-food product is a cream or lotion.

Examples of other products include but are not limited to paints, dyes, cosmetics, toothpaste, ointments, pharmaceuticals, polymer dispersions, pigment suspensions and adhesives. The fluid can for example be used for technical, medical and personal care applications, e.g. sports cream, sun lotion, etc.

In one embodiment, the viscosity of the fluid at 25° C. is from 500-300,000 cP. In another embodiment, the viscosity of the fluid at 25° C. is from 500-10,000 cP. In a further embodiment, the viscosity of the fluid at 25° C. is from 10,000-200,000 cP. In a further embodiment, the viscosity of the fluid at 25° C. is above 200,000 cP.

This invention further describes a method for forming a coating composition for coating a polymer surface as described herein comprising the following steps:
a. mixing at least one oil and at least one emulsifier to form a coating composition, which is a homogenous solution;
b. contacting said surface with said coating composition;
c. optionally, allowing excess coating to flow off said surface.

In order to obtain advantageous release properties of the coating composition, the coating composition comprising the at least one oil and the at least one emulsifier is mixed before application. If they are not mixed before application a two layer coating composition will be formed comprising at least one oil and at least one emulsifier, respectively. This two-layer coating composition does not provide comparable good release properties.

By “contacting said surface with the coating composition” is to be understood that the coating composition is applied to the surface by means commonly known to the skilled person in the art.

This invention further describes a use of a coating composition for improvement of release properties of a polymer surface by coating at least partly said surface with said coating composition comprising at least one oil and at least one emulsifier. Hereby, the release properties of the surface are improved as compared to the release properties of a surface without coating.

In a further use, said at least one emulsifier is a glycerol or a polyglycerol ester. In a still further use, said at least one emulsifier is selected from polyglycerol fatty acid esters (PGEs), citric acid ester of mono-diglycerides (CITREM), diacetyl tartaric ester of mono-diglycerides (DATEM) or a mixture of one or more hereof. In another embodiment, said at least one emulsifier is a monoglyceride or a mono-diglyceride of fatty acid esters.

In a further use, the HLB-value of the emulsifier is above 3, like above 4, such as above 4.5, like above 5. In a still further use, the HLB-value is in the range of around 7 to around 12. In a further embodiment, the HLB-value is above 2, such as above 2.5.

In one use, the viscosity of the coating composition at 25° C. is between 10 cP and 3000 cP. In a further use, the viscosity of the coating composition at 25° C. is between 20 cP and 1000 cP. In a still further use, the viscosity of the coating composition at 25° C. is between 100 cP and 800 cP. In a still further use, the viscosity of the coating composition at 25° C. is between 50 cP and 500 cP. In a still further use, the viscosity of the coating composition at 25° C. is between 50 cP and 100 cP.

In a further use, said oil is a vegetable oil. In a still further use, said oil is rapeseed oil, soybean oil, high oleic sunflower oil or a mixture of one or more hereof.

In a further use, said at least one emulsifier is present in an amount of 0.1-50 wt % of the coating. In a further use, said at least one emulsifier is present in an amount of 0.1-10 wt % of the coating. In a further use, said at least one emulsifier is present in an amount of 0.3-8 wt % of the coating. In a further use, said at least one emulsifier is present in an amount of 0.5-5 wt % of the coating.

In a further use, said surface is an inner surface forming a cavity in a container, where said cavity is connected to the outside with an outlet opening.

Different polymers can be used for the surface such as polyesters and polyolefins. Alternatively, other polymers such as thermoplastic, elastomeric, duroplastic polymers and thermoplastic elastomers can be used for the surface.

In a further use, said polymer is polypropylene (PP) or polyethylene terephthalate (PET).

In a still further use, said polymer is cellulose, natural fibers, cardboard or the like.

Hence, any polymer or plastic can be used, for instance polyolefins, polyvinyl chloride, polyesters, ionomers and polycarbohydrates. Besides synthetic polymers natural polymers and fibers, like polypeptides, celluloses or lignocellulosic materials, e.g. paper and cardboard can also be used.

In a further use, said surface is part of a structure, said structure comprises an internal additive. In a further use, said internal additive is distilled monoglyceride, a mono-diglyceride, a diglycerol ester or a mixture of one or more hereof.

In a further use, said fluid is a food product. In a still further use, said food product is mayonnaise or concentrated and non-concentrated fermented products.

Concentrated and non-concentrated fermented products are products such as but not limited to yogurt and Ymer® (a concentrated mesophilic product).

In a further use, said fluid is a non-food product. In a still further use, said non-food product is cream or lotion.

### BRIEF DESCRIPTION OF THE DRAWINGS

FIG. 1a illustrates retained mayonnaise on PET sheets modified with 1 wt % GRINDSTED® PGE 308 as an internal additive, and no coating;

FIG. 1b illustrates retained mayonnaise on PET sheets modified with 1 wt % GRINDSTED® PGE 308 as an internal additive and coated with rapeseed oil;

FIG. 1c illustrates retained mayonnaise on PET sheets modified with 1 wt % GRINDSTED® PGE 308 as an internal additive and coated with rapeseed oil+1 wt % GRINDSTED® PGE 308;

FIG. 1d illustrates retained mayonnaise on PET sheets modified with 1 wt % GRINDSTED® PGE 308 as an internal additive and coated with rapessed oil+3 wt % GRINDSTED® PGE 308;

FIG. 2a illustrates retained Ymer A38 on PET sheets with no internal additive, and no coating;

FIG. 2b illustrates retained Ymer A38 on PET sheets with no internal additive and coated with rapeseed oil+3 wt % GRINDSTED® PGE O 80;

FIG. 2c illustrates retained Ymer A38 on PET sheets with 1% DIMODAN® HP as internal additive and no coating;

FIG. 2d illustrates retained Ymer A38 on PET sheets with 1% DIMODAN® HP as internal additive and coated with rapeseed oil+3 wt % GRINDSTED® PGE O 80;

FIG. 3 illustrates PET bottles after mayonnaise release: without coating (left) and with a coating of 3 wt % Citrem SP70 in rapeseed oil (right).

FIG. 4a illustrates a PP bottle after mayonnaise release after 3 days of storage at 5° C. without coating.

FIG. 4b illustrates a PP bottle after mayonnaise release after 3 days of storage at 5° C. with a coating of 3 wt % Citrem SP70 in rapeseed oil.

### EXAMPLES

### Methods

### Cast Film Samples

Cast film was produced on a Brabender lab scale extruder. The film was extruded through a slit die, cooled and drawn to its desired thickness on a Brabender Univex calendering system.

Amorphous polyethylene terephthalate (APET) cast film thickness: 300-400 μm.

Random polypropylene (PP) cast film thickness: 500-600 μm.

### Polymer Film Samples:

APET with no internal additive added

APET with 1.0% GRINDSTED® PGE 308 added

APET with 1.0% GRINDSTED® PS 101 added

APET with 1.0% DIMODAN® HP added

APET with 0.3% DIMODAN® HP added

APET with 1.0% DIMODAN® HR added

Random copolymer polypropylene (PP) with no internal additive added

Random PP with 1% GRINDSTED® PGE 308

Random PP with 0.3% DIMODAN® HP

Random PP with 1% DIMODAN® HP

Random PP with 3.0% DIMODAN® HP

### Cutting Test Specimens:

Test specimens were cut in 4×6 cm pieces on a paper cutting machine.

Test specimens were moved and handled with tweezers and only touched when wearing gloves.

Test specimens were weighed to an accuracy of +/−0.1 mg prior to submerging in coating and/or product.

### Coating of Polymer Test Specimens

The 4×6 polymer specimens were completely immersed in the coating solution contained in a 100 ml lab glass container. The specimens were handled with tweezers during the entire coating process. After removing the specimens from the coating solution, excessive coating material was allowed to run off by placing the specimens vertically for 30 minutes. Specimens were then weighed and the amount of coating determined. The coated specimens were then ready to be submerged in the product (e.g. mayonnaise).

### Coatings Evaluated:

100% rapeseed oil

100% high oleic sunflower oil

100% olive oil

100% grapeseed oil

Medium chain triglyceride (MCT)

Rapeseed oil with 1% GRINDSTED® PGE 308 added

Rapeseed oil with 3% GRINDSTED® PGE 308 added

Rapeseed oil with 1% GRINDSTED® PGE O 80 added

Rapeseed oil with 3% GRINDSTED® PGE O 80 added

Rapeseed oil with 0.2% CITREM SP70 added

Rapeseed oil with 0.5% CITREM SP70 added

Rapeseed oil with 3% CITREM SP70 added

Rapeseed oil with 6% CITREM SP70 added

Rapeseed oil with 10% CITREM SP70 added

Rapeseed oil with 3% PANODAN® AB added

Rapeseed oil with 3% PANODAN® Visco-Lo added

Rapeseed oil with 3% PGPR added

Rapeseed oil with 3% Lecithin added

High oleic sunflower oil with 3% PGE 080 added

High oleic sunflower oil with 3% Citrem SP 70 added

High oleic sunflower oil with 3% Panodan AB 100 added

Olive Oil with 3% Citrem SP 70

Grapeseed oil with 3% Citrem SP 70

MCT with 3% PGE 308

### Test Container:

Small 150 ml buckets made from high-density polyethylene (HDPE) and with a low-density polyethylene (LDPE) lid. The product e.g. mayonnaise was transferred to a test container with a spoon and was levelled with the top of the container. Each container could hold three fully submerged test specimens.

### Immersion of Test Specimens in the Product

The product was stirred to a homogeneous mixture and levelled with the top of the container prior to immersion of test specimens.

The test specimens cut from the cast film was immersed in the product and was completely covered.

The lid was put on the container and it was stored at 5° C. for one day to 56 days.

All samples were determined in triplicates. The results in the tables are average values of the three measurements.

Retrieving Test Specimens from Product:

After storage, test specimens were removed from the test container with tweezers and weighed to an accuracy of +/−0.1 mg.

The weight of the retained product was calculated.

### Weight of Test Specimens:

All polymer specimens cut in a 4×6 cm size were weighed with an accuracy of +/−0.1 mg.

All coated specimens were weighed with an accuracy of +/−0.1 mg and total weight of coating was calculated and recorded.

All specimens were weighed after they were retrieved from the product test container and weighed after the product was no longer dripping off the specimen when held in a vertical position, which typically occurs within one minute.

Total amount of product was calculated from weight measurements and results were recorded and used to evaluate efficiency of the coating.

### Measurement of Viscosity

The viscosity data were obtained at 25° C. at a shear rate of 10/s using an Anton Paar MCR301 rotational rheometer.

### Description of Applied Oils, Internal Additives and Emulsifiers

| Components | Description |
|---|---|
| Rapeseed oil | Oil derived from rapeeeds |
| MCT 60 X (MCT) | Glyceryl Tricaprylate-caprate derived from palm oil |
| High oleic sunflower oil | Oil derived from sunflower seeds with high oleic acid content |
| Olive oil | Oil derived from olives |
| Grapeseed oil | Oil derived from seeds from grapes |
| GRINDSTED ® PGE 308 (PGE 308) | Polyglycerol ester (PGE) |
| GRINDSTED ® PGE O80 (PGE O80) | Polyglycerol ester (PGE) |
| Citrem SP70 | Citric acid ester of mono-diglyceride (CITREM) |
| PANODAN ® AB | Diacetyl tartaric ester of mono-diglycerides (DATEM) |
| PANODAN ® Visco-Lo | Diacetyl tartaric ester of mono-diglycerides (DATEM) |
| Polyglycerol polyricinoleate | Polyglycerol ester of polycondensed fatty acids from castor oil |
| (PGPR) | |
| DIMODAN ® HP | Distilled monoglyceride from hydrogenated palm oil |
| DIMODAN ® HR | Distilled monoglyceride from hydrogenated rapeseed oil |

Release Studies from Polymer Bottles

In addition to the experiments with cast film polymer samples, food release from polymer bottles was tested. Two different bottle types were prepared: PP bottles with a volume of 450 ml and PET bottles with a volume of 175 ml.

Uncoated and coated polymer bottles were filled with a 80 wt % fat containing, oil-in-water mayonnaise formulation. For PP, the bottles were either uncoated or coated with rapeseed oil containing 3 wt % of Citrem SP70. For PET, the bottles were either uncoated, coated with rapeseed oil alone or rapeseed oil containing 3 wt % Citrem SP70.

The coating liquids were applied by rinsing the bottles with the coating liquid and removing any excess liquid by turning the bottles upside down and allowing the liquid to flow freely from the bottles. Hereafter, the bottles were completely filled with mayonnaise and stored at 5° C.

The PET bottles were stored for 22 days, while the PP bottles were stored for 3, 14, 35 and 56 days. The mayonnaise was released from the bottles by turning the bottles upside down and allowing the mayonnaise to flow freely from the bottle. The bottles were turned for 2 h at 25° C., followed by 12 cycles of taping and mechanical squeezing. The residual amounts of mayonnaise were determined by the weight differences before and after filling and releasing the mayonnaise.

### Results

### EXAMPLE 1

### Product Release Properties of Mayonnaise from PET Surfaces

PET surfaces were coated with a multiplicity of coating compositions as described in Table 1-4.

As can be seen from the tables, the addition of a coating to the surface of the samples highly increased the amount of product released from the surface as compared to where no coating was added.

Furthermore it can be seen that the results are dependent upon the type of coating applied to the surface.

In addition it can be seen from Table 1 that adding only 1% of an emulsifier to the oil before coating the surface with the coating composition results in further 78% of the remaining product to be removed from the surface as compared to a pure oil coating. This is even further increased to 89% if the amount of emulsifier is increased to 3% of the coating composition.

TABLE 1
APET cast film samples without internal additive tested
with mayonnaise (80% fat content) after 1 day.

| | | | Improvement |
|---|---|---|---|
| | Remaining | Improvement | compared to |
| Coating composition | product | compared to no | rapeseed oil coating |
| in wt % | in wt % | coating in % | in % |
| No coating | 6.8 | 0 | |
| 100% rapeseed oil | 1.8 | 74 | 0 |
| 1% PGE308 in | 0.4 | 94 | 78 |
| rapeseed oil | | | |
| 3% PGE308 in | 0.2 | 97 | 89 |
| rapeseed oil | | | |

TABLE 2
APET cast film samples without internal additive
tested with mayonnaise (80% fat content) after 3 days.

| Coating | Remaining | Improvement compared |
|---|---|---|
| composition in wt % | product in wt % | to no coating in % |
| No coating | 7.5 | 0 |
| 100% rapeseed oil | 1.8 | 76 |
| 3% Lecithin in rapeseed oil | 0.6 | 92 |
| 3% Citrem SP70 in | 0.2 | 97 |
| rapeseed oil | | |

TABLE 3
APET cast film samples without internal additive tested
with mayonnaise (80% fat content) after 3 days.

| | | Improvement |
|---|---|---|
| | Remaining | compared to |
| Coating composition in wt % | product in wt % | no coating in % |
| No coating | 7.5 | 0 |
| 100% MCT | 1.8 | 76 |
| 3% PANODAN ® AB in | 0.6 | 90 |
| rapeseed oil | | |
| 3% PANODAN ® Visco-Lo in | 0.8 | 86 |
| rapeseed oil | | |

TABLE 4
APET cast film samples without internal additive tested
with mayonnaise (80% fat content) after 3 days.

| | | Improvement |
|---|---|---|
| | Remaining | compared to |
| Coating composition in wt % | product in wt % | no coating in % |
| No coating | 6.1 | 0 |
| 3% PGPR in Rapeseed oil | 1.0 | 84 |
| Water/rapeseed oil/PGPR | 1.3 | 79 |
| (60/36/4) | | |
| 3% PGE O80 in high oleic | 0.2 | 97 |
| sunflower oil | | |

### EXAMPLE 2

### Product Release Properties of Mayonnaise from PET Surfaces Comprising Internal Additives

PET samples were modified with additives and submerged into mayonnaise. After three days, the polymer sheets (test specimens) were removed from the mayonnaise to determine the remaining amount mayonnaise on the sheets.

Without coating, the release properties for mayonnaise can be improved by an internal additive (DIMODAN® HP) by 43% (see Table 5). However, applying rapeseed oil as an external coating enables even better release properties of about 64% less product with and without internal additive (compared to the uncoated reference with no internal additive). Surprisingly adding only 1 wt % or 3 wt % surface active additive (GRINDSTED® PGE 308) to rapeseed oil leads to further improvement of release properties of up to 97% improvement (only 0.2 wt % product left on the polymer sheet, compared to 5.8 wt % for non-modified PET, see Table 5).

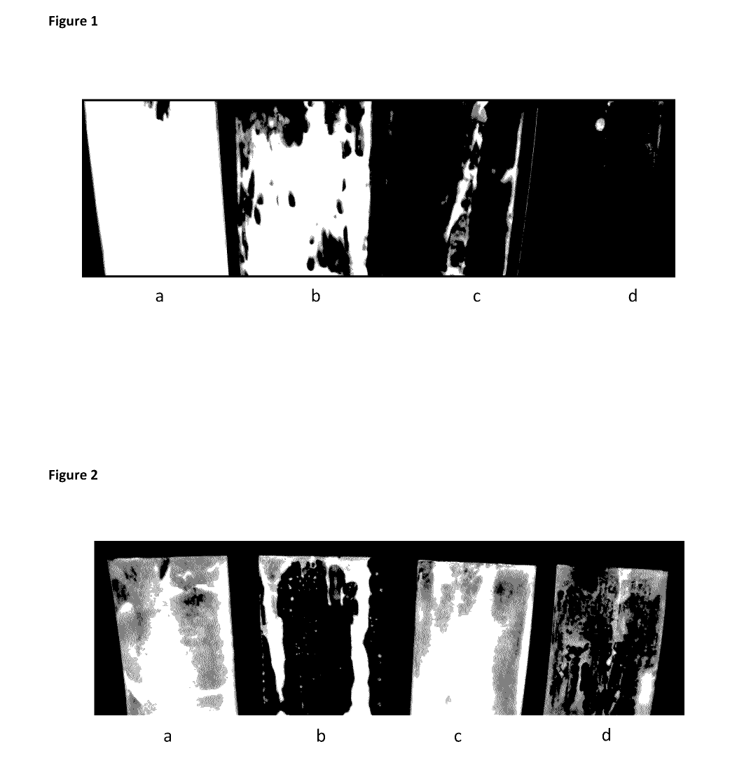

FIG. 1 illustrates comparable PET samples directly after removal from the mayonnaise. The samples were all modified with 1 wt % of GRINDSTED® PGE 308 as an internal additive. FIG. 1 a illustrates a sample with no coating setting the threshold for release of mayonnaise from the surface. FIG. 1b illustrates a sample coated with rapeseed oil only (RS) showing an additional product release compared to the non-coated sample of 71%. FIG. 1c illustrates a sample coated with rapeseed oil+1 wt % GRINDSTED® PGE 308 showing an additional product release compared to the non-coated sample of 93%. FIG. 1d illustrates a sample coated with rapeseed oil+3wt % GRINDSTED® PGE 308 showing an additional product release compared to the non-coated sample of 97%.

Though the increase in viscosity by adding 1 wt % or 3 wt % of GRINDSTED® PGE 308 to rapeseed oil is marginal (1.3%, respectively 5.8%), the increase of the adhesion of the coating solution itself is highly increased compared to rapeseed oil only (2.3-3.1 wt % compared to 1.2-1.4 wt %). This indicates that the adhesion of the coating solution to the polymer surface is mainly increased by the change in interfacial energies and improved wetting, rather than an increase in viscosity of the coating solutions.

TABLE 5
APET cast film samples with internal additive tested with mayonnaise (80% fat content)

| Coating | Internal | Storage | Remaining | | Improvement | Improvement |
|---|---|---|---|---|---|---|
| composition | additive in | time | product in | Improvement | compared to | compared to |
| in wt % | wt % | days | wt % | in %* | no coating in % | oil coating in % |
| No coating | No additive | | 5.8 | 0 | | |
| No coating | 1% | 1 | 3.3 | 43 | 0.0 | |
| | DIMODAN ® | | | | | |
| | HP | | | | | |
| 100% | 1% | 1 | 2.1 | 64 | 36 | 0.0 |
| rapeseed oil | DIMODAN ® | | | | | |
| | HP | | | | | |
| 1% PGE 308 | 1% | 1 | 0.7 | 88 | 79 | 67 |
| in rapeseed oil | DIMODAN ® | | | | | |
| | HP | | | | | |
| 3% PGE 308 | 1% | 1 | 0.3 | 95 | 91 | 86 |
| in rapeseed oil | DIMODAN ® | | | | | |
| | HP | | | | | |
| No coating | 1% | 1 | 7.0 | -21 | 0 | |
| | GRINDSTED ® | | | | | |
| | PGE 308 | | | | | |
| 100% | 1% | 1 | 2.0 | 66 | 71 | 0.0 |
| rapeseed oil | GRINDSTED ® | | | | | |
| | PGE 308 | | | | | |
| 1% PGE 308 | 1% | 1 | 0.5 | 91 | 93 | 75 |
| in rapeseed oil | GRINDSTED ® | | | | | |
| | PGE 308 | | | | | |
| 3% PGE 308 | 1% | 1 | 0.2 | 97 | 97 | 90 |
| in rapeseed oil | GRINDSTED ® | | | | | |
| | PGE 308 | | | | | |
| No coating | 1% | 1 | 6.7 | -16 | 0 | |
| | GRINDSTED ® | | | | | |
| | PS101 | | | | | |
| 100% | 1% | 1 | 1.3 | 78 | 81 | 0 |
| rapeseed oil | GRINDSTED ® | | | | | |
| | PS101 | | | | | |
| 1% PGE 308 | 1% | 1 | 0.5 | 91 | 93 | 62 |
| in rapeseed oil | GRINDSTED ® | | | | | |
| | PS101 | | | | | |
| 3% PGE 308 | 1% | 1 | 0.2 | 97 | 97 | 85 |
| in rapeseed oil | GRINDSTED ® | | | | | |
| | PS101 | | | | | |
| No coating | 1% | 1 | 4.1 | 29 | 0 | |
| | DIMODAN ® | | | | | |
| | HR | | | | | |
| 100% | 1% | 1 | 2.0 | 66 | 51 | 0 |
| rapeseed oil | DIMODAN ® | | | | | |
| | HR | | | | | |
| 1% PGE 308 | 1% | 1 | 0.6 | 90 | 86 | 70 |
| in rapeseed oil | DIMODAN ® | | | | | |
| | HR | | | | | |
| 3% PGE 308 | 1% | 1 | 0.3 | 95 | 93 | 85 |
| in rapeseed oil | DIMODAN ® | | | | | |
| | HR | | | | | |
| 100% | 1% | 2 | 2.9 | 50 | | 0 |
| rapeseed oil | DIMODAN ® | | | | | |
| | HR | | | | | |
| 1% PGE 308 | 1% | 2 | 0.4 | 93 | | 86 |
| in rapeseed oil | DIMODAN ® | | | | | |
| | HR | | | | | |
| 3% PGE O 80 | 1% | 2 | 0.4 | 93 | | 86 |
| in rapeseed oil | DIMODAN ® | | | | | |
| | HR | | | | | |

*in relation to a surface having no coating and no internal additive

Furthermore from Table 5 it can be observed that adding an emulsifier to the coating composition increases the release of product from the surface with 67-90% as compared to a coating composition without emulsifier.

### EXAMPLE 3

### Product Release Properties of Ymer A38 from PET Surfaces

Ymer A38 is a sour milk-based, yogurt-like dairy product (a concentrated mesophilic product) similar to yogurt. The PET samples were modified with additives and submerged into the Ymer. After three days at 5° C. the polymer sheets (test specimens) were removed from the product and the remaining amount of product (Ymer A38) on the polymer sheets were determined.

In case of Ymer A38, and in contrast to Example 1, the use of internal additive only is not improving the product release properties. However, applying a coating solution of rapeseed oil containing 3 wt % GRINDSTED® PGE O 80 leads to an improvement of product release of 75% (i.e. 75 wt % less product left on the polymer compared to the reference without additives). An improvement is also observed for the sample without 1 wt % DIMODAN® HP as internal additive (Table 6).

TABLE 6
APET cast film samples with and without internal
additive tested with Ymer A38 after 3 days

| | | Remaining | |
|---|---|---|---|
| Coating | Internal | product | Improvement |
| composition in wt % | additive in wt % | in wt % | in %* |
| No coating | No additive | 2.8 | 0 |
| No coating | 1% DIMODAN ® HP | 2.9 | −3.6 |
| 3% PGE 308 in | No additive | 0.9 | 68 |
| rapeseed oil | | | |
| 3% PGE O 80 in | 1% DIMODAN ® HP | 0.7 | 75 |
| rapeseed oil | | | |

*in relation to a surface having no coating and no internal additive

FIG. 2 illustrates comparable PET samples directly after removal from the Ymer A38. FIG. 2a illustrates a sample with no coating and no internal additive setting the threshold for release of Ymer A38 from the surface. FIG. 2b illustrates a sample coated with rapeseed oil+3 wt % GRINDSTED® PGE O 80 and with no internal additive. This sample showed an additional product release compared to the non-coated sample of 68%. FIG. 2c illustrates a sample with no coating but with 1% DIMODAN® HP as internal additive. This sample showed an additional product release compared to the non-coated sample of −3.6%. FIG. 2d illustrates a sample coated with rapeseed oil+3 wt % GRINDSTED® PGE O 80 with 1% DIMODAN® HP as internal additive. This sample showed an additional product release compared to the non-coated sample of 75%.

### EXAMPLE 4

### Product Release Properties of Sun Lotion from PET Surfaces

The described approach is not limited to food release and food packaging, but can be applied also for any other viscous fluids. For instance, the improved release of sun lotion has been demonstrated for PET samples modified with additives.

The use of 1 wt % DIMODAN® HP as internal additive without additional coating improves the release of sun lotion by about 13% (13% less product left on the polymer surface compared to the reference without any internal or external additive). Applying a coating solution of rapeseed oil containing 3 wt % GRINDSTED® PGE O 80, results in an even higher improvement of about 33% (Table 7).

TABLE 7
APET cast film samples with and without internal
additive tested with Sun Lotion (after 3 days)

| Coating | | Remaining | |
|---|---|---|---|
| composition in | Internal | product in | Improvement |
| wt % | additive in wt % | wt % | in %* |
| No coating | No additive | 6.4 | 0 |
| No coating | 1% DIMODAN ® HP | 5.6 | 13 |
| 3% PGE O 80 in | No additive | 4.5 | 30 |
| rapeseed oil | | | |
| 3% PGE 308 in | No additive | 4.2 | 34 |
| rapeseed oil | | | |
| 3% PGE O 80 in | 1% DIMODAN ® HP | 4.2 | 34 |
| rapeseed oil | | | |
| 3% PGE 308 in | 1% DIMODAN ® HP | 4.4 | 31 |
| rapeseed oil | | | |

*in relation to a surface having no coating and no internal additive

Though the effect in this example is not as pronounced as e.g. in the case of mayonnaise it is noteworthy, taking the commercial value of the product into account. In this respect the added value of the demonstrated product release solution can still be of a similar magnitude.

### EXAMPLE 5

### Product Release Properties of Mayonnaise from PP Cast Film Surfaces

The described approach is not limited to PET as a polymer, but can be applied also for other surfaces. In the following the release of mayonnaise is demonstrated for random PP samples modified with internal additives and different coating compositions.

As shown in Table 8-11 the use of internal additive could improve the mayonnaise release properties, but it could also increase the remaining amount of product on the polymer (e.g. when applying 1 wt % DIMODAN® HR as an internal additive). The use of oils as coating composition highly improved the release of mayonnaise in all cases, with and without internal additive. The product release properties of medium chain triglycerides (MCT) were better than for rapeseed oil alone (Table 9 and Table 10). However, using coating solutions of rapeseed oil containing 3 wt % GRINDSTED® PGE O 80 resulted in a step change performance, even compared to MCT, and improved release properties of up to 97% (see Table 11).

TABLE 8
Random PP cast film samples without internal additive
and mayonnaise (80% fat content) after 1 day

| | | Improvement | Improvement | |
|---|---|---|---|---|
| Coating | Remaining | compared | compared | |
| composition in | product | to no | to oil | |
| wt % | in wt % | coating in % | coating in % | Viscosity |
| No coating | 6.6 | 0 | | |
| 100% rapeseed oil | 2.7 | 59 | 0 | 71 cP |
| 1% PGE O 80 in | 1.5 | 77 | 44 | 72 cP |
| rapeseed oil | | | | |
| 3% PGE O 80 in | 0.7 | 89 | 74 | 75 cP |
| Rapeseed oil | | | | |

Table 8 show improved release properties with increasing viscosities. Compared to a coating with rapeseed oil only (71 cP viscosity), the release properties for a coating with additional 1 wt % or 3 wt % GRINDSTED PGE O 80 are improved by 44% and 74% despite the increase in viscosity to 72 cP and 75 cP, respectively.

TABLE 9
Random PP cast film samples with internal additive
and mayonnaise (80% fat content) after 1 day

| | | Remaining | Improvement |
|---|---|---|---|
| Coating composition | Internal | product | compared to no |
| in wt % | additive | in wt % | coating in % |
| No coating | 1% PGE 308 | 3.3 | 0 |
| 100% rapeseed oil | 1% PGE 308 | 2.9 | 12 |
| 100% MCT | 1% PGE 308 | 1.1 | 67 |

TABLE 10
Random PP cast film samples with internal additive
and mayonnaise (80% fat content) after 1 day

| | | Remaining | Improvement |
|---|---|---|---|
| Coating composition | | product | compared to no |
| in wt % | Internal additive | in wt % | coating in % |
| No coating | 1% DIMODAN ® HP | 7.5 | 0 |
| 100% rapeseed oil | 1% DIMODAN ® HP | 3.6 | 52 |
| 100% MCT | 1% DIMODAN ® HP | 1.6 | 79 |

TABLE 11
Random PP cast film samples with internal additive
and mayonnaise (80% fat content) after 1 day

| Coating | | | Improvement | Improvement |
|---|---|---|---|---|
| composition in | | Remaining | compared to no | compared to oil |
| wt % | Internal additive | product in wt % | coating in % | coating in % |
| No coating | 1% DIMODAN ® | 9.9 | 0 | |
| | HR | | | |
| 100% rapeseed | 1% DIMODAN ® | 1.2 | 88 | 0 |
| oil | HR | | | |
| 1% PGE 308 in | 1% DIMODAN ® | 0.7 | 93 | 42 |
| rapeseed oil | HR | | | |
| 3% PGE O 80 in | 1% DIMODAN ® | 0.3 | 97 | 75 |
| rapeseed oil | HR | | | |

### EXAMPLE 6

### Long-Term Performance Testing of Coated PET and PP Cast Film Samples (Over 2 Months Storage Time at 5° C.)

Long-term tests confirmed the improved product release properties of rapeseed oil coatings containing 3 wt % of GRINDSTED PGE 080 or CITREM SP-70 compared to MCT coatings. The coated cast film polymer samples of PET (Table 12) and PP (Table 13) have been stored in mayonnaise at 5° C. up to 2 months. After 3, 14, 28 and 56 days the polymer samples have been removed and the remaining amount of mayonnaise determined.

TABLE 12
Long-term release study of mayonnaise from coated
PET cast film samples after 3, 12, 28 and 56 days storage.

| | | | | Improvement |
|---|---|---|---|---|
| Coating | days of | Remaining | Improvement | compared |
| composition | storage | product | compared to no | to MCT |
| in wt % | at 5° C. | in wt % | coating in % | coating in % |
| No coating | 3 | 8.2 | 0 | |
| | 14 | 5.9 | 0 | |
| | 28 | 6.3 | 0 | |
| | 56 | 4.3 | 0 | |
| 100% MCT | 3 | 1.6 | 80 | 0 |
| | 14 | 1.6 | 73 | 0 |
| | 28 | 2.2 | 65 | 0 |
| | 56 | 2.0 | 53 | 0 |
| 3% PGE O 80 | 3 | 1.0 | 87 | 38 |
| in rapeseed oil | | | | |
| | 14 | 1.4 | 77 | 13 |
| | 28 | 1.3 | 80 | 41 |
| | 56 | 0.6 | 86 | 70 |
| 3% Citrem SP70 | 3 | 0.4 | 95 | 75 |
| in rapeseed oil | | | | |
| | 14 | 0.5 | 92 | 69 |
| | 28 | 0.4 | 94 | 82 |
| | 56 | 0.3 | 94 | 85 |

For PET, which has a higher polarity compared to polyolefins, the emulsifier containing coatings showed a very stable performance over the tested period of time.

In contrast, the food release effect of MCT as a coating is not only significantly lower from the beginning, but also much faster diminishing during the storage of the specimen. For instance, after 2 month a coating of rapeseed oil containing 3 wt % Citrem SP70 is performing 85% better than a coating with MCT for PET, and 78% better than MCT for PP.

TABLE 13
Long-term release study of mayonnaise from coated PP cast
film samples after 3, 12, 28 and 56 days storage.

| | | | | Improvement |
|---|---|---|---|---|
| Coating | days of | Remaining | Improvement | compared to |
| composition | storage | product | compared to no | MCT coating |
| in wt % | at 5° C. | in wt % | coating in % | in % |
| No coating | 3 | 8.1 | 0 | |
| | 14 | 6.0 | 0 | |
| | 28 | 5.7 | 0 | |
| | 56 | 4.6 | 0 | |
| 100% MCT | 3 | 2.5 | 70 | 0 |
| | 14 | 2.1 | 65 | 0 |
| | 28 | 2.2 | 61 | 0 |
| | 56 | 1.3 | 71 | 0 |
| 3% PGE O 80 | 3 | 1.4 | 83 | 44 |
| in rapeseed oil | | | | |
| | 14 | 1.8 | 70 | 14 |
| | 28 | 1.2 | 78 | 45 |
| | 56 | 0.6 | 86 | 54 |
| 3% Citrem SP70 | 3 | 0.3 | 96 | 88 |
| in rapeseed oil | | | | |
| | 14 | 0.4 | 93 | 81 |
| | 28 | 0.3 | 94 | 86 |
| | 56 | 0.3 | 94 | 78 |

Experiment 7: Release Studies from Polymer Bottles

TABLE 14
Product release of mayonnaise from PET
bottles after 22 days storage at 5° C.

| Coating | Remaining | Improvement | Improvement |
|---|---|---|---|
| composition | product | compared to no | compared to oil |
| in wt % | in wt % | coating in % | coating in % |
| No coating | 39 | 0 | |
| 100% rapeseed oil | 18 | 54 | 0 |
| 3% Citrem SP70 in | 6 | 85 | 67 |
| rapeseed oil | | | |

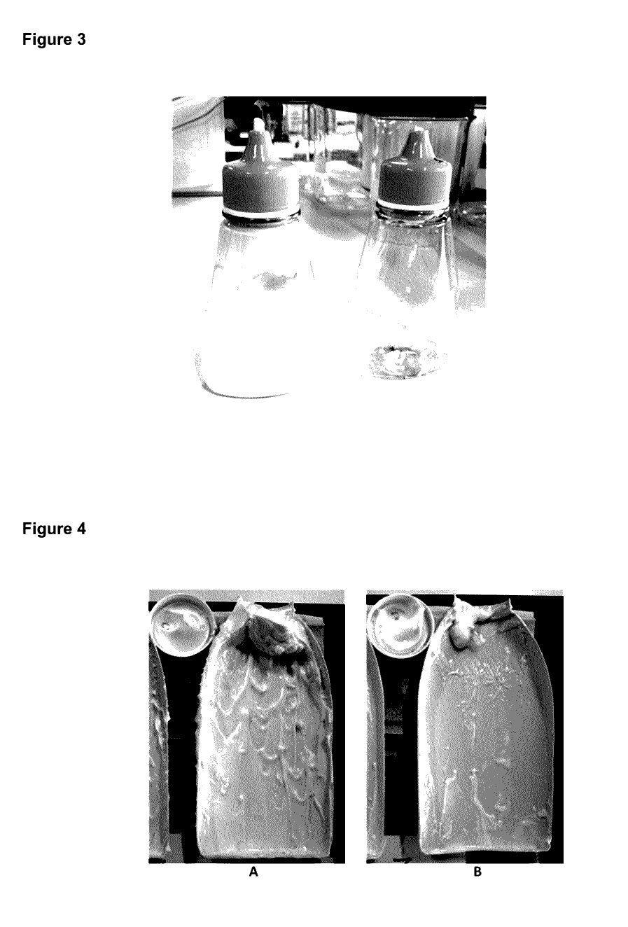

FIG. 3 shows the comparison of the two PET bottles with no coating (left) and with a coating of 3 wt % Citrem SP70 in rapeseed oil (right). In the latter case the remaining mayonnaise is mainly located in the bottle opening (for geometrical reasons), while only marginal amounts are left at the bottle wall. This is also illustrated in Table 14, where the remaining product is reduced by 67% by adding 3% Citrem SP70 to the rapeseed oil before coating the surface.

TABLE 15
Product release of mayonnaise from PP bottles
after 3, 14, 35 and 56 days of storage at 5° C.

| Coating | days of | Remaining | Improvement |
|---|---|---|---|
| composition | storage | product | compared to no |
| in wt % | at 5° C. | in wt % | coating in % |
| No coating | 3 | 21 | 0 |
| | 14 | 22 | 0 |
| | 35 | 17 | 0 |
| | 56 | 22 | 0 |
| 3% Citrem SP70 | 3 | 7 | 67 |
| in rapeseed oil | | | |
| | 14 | 7 | 68 |
| | 35 | 9 | 47 |
| | 56 | 9 | 59 |

FIGS. 4a and 4b show the comparison of the two PP bottles with no coating (FIG. 4a) and with a coating of 3 wt % Citrem SP70 in rapeseed oil (FIG. 4b). The remaining mayonnaise is mainly located in the neck of the bottle and in the bottle's cap. The wall of the coated bottle is mostly free of any remaining mayonnaise, while the uncoated bottle retains significantly larger amount. This is also described in Table 15 where the remaining product is reduced between 47 and 68% when coating with rapeseed oil and 3% Citrem SP70 as compared to the bottles without coating.

Experiment 8: Coating of APET Cast Film Samples with Rapeseed Oil and Citrem SP 70

TABLE 16
APET cast film samples without internal additive tested
with mayonnaise (80% fat content) after 3 days.

| Coating | Remaining | Improvement | Improvement |
|---|---|---|---|
| composition | product | compared to no | compared to oil |
| in wt % | in wt % | coating in % | coating in % |
| No coating | 7.8 | 0 | |
| 100% rapeseed oil | 3.1 | 60 | 0 |
| 0.2% Citrem SP 70 in | 1.7 | 78 | 45 |
| rapeseed oil | | | |
| 0.5% Citrem SP 70 in | 1.0 | 88 | 68 |
| rapeseed oil | | | |

TABLE 17
APET cast film samples without internal additive tested
with mayonnaise (80% fat content) after 14 days.

| Coating | Remaining | Improvement | Improvement |
|---|---|---|---|
| composition | product | compared to no | compared to oil |
| in wt % | in wt % | coating in % | coating in % |
| No coating | 5.4 | 0 | |
| 100% rapeseed oil | 2.0 | 62 | 0 |
| 0.2% Citrem SP 70 in | 1.3 | 77 | 35 |
| rapeseed oil | | | |
| 0.5% Citrem SP 70 in | 0.8 | 84 | 60 |
| rapeseed oil | | | |

As shown in Tables 16 and 17 even relatively low amounts i.e. 0.2% and 0.5% of Citrem SP70 increases the release properties of a rapeseed oil coating between 35 and 68%. From the experiments it can be seen that this effect is kept even after 14 days of storage.

Experiment 9: Coating of APET Cast Film Samples with High Oleic Sunflower Oil and 3% Emulsifier

TABLE 18
APET cast film samples without internal additive tested
with mayonnaise (80% fat content) after 3 days.

| Coating | Remaining | Improvement | Improvement |
|---|---|---|---|
| composition | product | compared to no | compared to oil |
| in wt % | in wt % | coating in % | coating in % |
| No coating | 8.1 | 0 | |
| 100% high oleic sunflower | 1.8 | 78 | 0 |
| oil | | | |
| 3% Citrem SP 70 in high | 0.3 | 96 | 83 |
| oleic sunflower oil | | | |
| 3% Panodan AB 100 in | 0.5 | 94 | 72 |
| high oleic sunflower oil | | | |

TABLE 19
APET cast film samples without internal additive tested
with mayonnaise (80% fat content) after 14 days.

| Coating | Remaining | Improvement | Improvement |
|---|---|---|---|
| composition | product | compared to no | compared to oil |
| in wt % | in wt % | coating in % | coating in % |
| No coating | 6.9 | 0 | |
| 100% high oleic sunflower | 1.8 | 75 | 0 |
| oil | | | |
| 3% Citrem SP 70 in high | 0.4 | 95 | 78 |
| oleic sunflower oil | | | |
| 3% Panodan AB 100 in | 0.3 | 96 | 83 |
| high oleic sunflower oil | | | |

As shown in Tables 18 and 19 the release effect of the emulsifier is not only observed in rapeseed oil but also in oleic sunflower oil. Addition of 3% Citrem SP 70 or 3% Panodan AB 100 both increased the release efficiency of the high oleic sunflower oil by 72-83%. Furthermore, it is shown that this effect is kept even after 14 days of storage.

Experiment 10: Coating of APET with Olive Oil or Grapeseed Oil and Citrem SP 70

TABLE 20
APET cast film samples without internal additive tested
with mayonnaise (80% fat content) after 3 days.

| Coating | Remaining | Improvement | Improvement |
|---|---|---|---|
| composition | product | compared to no | compared to oil |
| in wt % | in wt % | coating in % | coating in % |
| No coating | 8.1 | 0 | |
| 100% olive oil | 2.9 | 64 | 0 |
| 3% Citrem SP 70 in olive | 0.5 | 94 | 83 |
| oil | | | |
| 100% grapeseed oil | 1.9 | 77 | 0 |
| 3% Citrem SP 70 in | 0.4 | 95 | 79 |
| grapeseed oil | | | |

TABLE 21
APET cast film samples without internal additive tested
with mayonnaise (80% fat content) after 14 days.

| Coating | Remaining | Improvement | Improvement |
|---|---|---|---|
| composition | product | compared to no | compared to oil |
| in wt % | in wt % | coating in % | coating in % |
| No coating | 6.2 | 0 | |
| 100% olive oil | 1.7 | 72 | 0 |
| 3% Citrem SP 70 in olive | 0.4 | 94 | 76 |
| oil | | | |
| 100% grapeseed oil | 1.2 | 81 | 0 |
| 3% Citrem SP 70 in | 0.4 | 94 | 67 |
| grapeseed oil | | | |

As shown in Tables 20 and 21 the release effect is not only observed in rapeseed oil but also in olive oil and grapeseed oil. The release effect is further improved when adding emulsifier in the form of 3% Citrem SP 70 to the oil before coating increasing the effect of the coating with 76% and 67%, respectively as compared with oil alone. Furthermore, it is shown that this effect is kept even after 14 days of storage.

Experiment 11: Coating of Random PP with Rapeseed Oil and Citrem SP 70

TABLE 22
PP cast film samples with 0.3 wt % Dimodan HP as internal additive,
tested with mayonnaise (80% fat content) after 3 days.

| Coating | Remaining | Improvement | Improvement |
|---|---|---|---|
| composition | product | compared to no | compared to oil |
| in wt % | in wt % | coating in % | coating in % |
| No coating | 6.7 | 0 | |
| 100% rapeseed oil | 3.3 | 51 | 0 |
| 3% Citrem SP 70 in | 0.3 | 96 | 91 |
| rapeseed oil | | | |

TABLE 23
PP cast film samples with 0.3 wt % Dimodan HP as internal additive,
tested with mayonnaise (80% fat content) after 14 days.

| Coating | Remaining | Improvement | Improvement |
|---|---|---|---|
| composition | product | compared to no | compared to oil |
| in wt % | in wt % | coating in % | coating in % |
| No coating | 5.5 | 0 | |
| 100% rapeseed oil | 2.1 | 61 | 0 |
| 3% Citrem SP 70 in | 0.2 | 96 | 90 |
| rapeseed oil | | | |

TABLE 24
PP cast film samples with 3.0 wt % Dimodan HP as internal additive,
tested with mayonnaise (80% fat content) after 3 days.

| Coating | Remaining | Improvement | Improvement |
|---|---|---|---|
| composition | product | compared to no | compared to oil |
| in wt % | in wt % | coating in % | coating in % |
| No coating | 7.7 | 0 | |
| 100% rapeseed oil | 2.5 | 68 | 0 |
| 3% Citrem SP 70 in | 0.5 | 94 | 80 |
| rapeseed oil | | | |

TABLE 25
PP cast film samples with 3.0 wt % Dimodan HP as internal additive,
tested with mayonnaise (80% fat content) after 14 days.

| Coating | Remaining | Improvement | Improvement |
|---|---|---|---|
| composition | product | compared to no | compared to oil |
| in wt % | in wt % | coating in % | coating in % |
| No coating | 7.7 | 0 | |
| 100% rapeseed oil | 2.0 | 74 | 0 |
| 3% Citrem SP 70 in | 0.4 | 95 | 80 |
| rapeseed oil | | | |

As shown in Tables 22-25, the release effect of the coating is observed when using internal additive both for a relative high and a relative low amount of internal additive. The release effect is further improved when adding emulsifier in the form of 3% Citrem SP 70 to the oil before coating increasing the effect of the coating with 80%-90% as compared with oil alone. Furthermore, it is shown that this effect is kept even after 14 days of storage.

Experiment 12: Coating of APET with Rapeseed Oil and Citrem LR 10

TABLE 26
APET cast film samples without internal additive tested
with mayonnaise (80% fat content) after 3 days.

| Coating | Remaining | Improvement |
|---|---|---|
| composition | product | compared to no |
| in wt % | in wt % | coating in % |
| No coating | 8.4 | 0 |
| 3% Citrem LR 10 in | 0.5 | 94 |
| rapeseed oil | | |
| 6% Citrem LR 10 in | 0.4 | 95 |
| rapeseed oil | | |
| 10% Citrem LR 10 in | 0.4 | 95 |
| rapeseed oil | | |

As shown in Table 26 the release effect is observed in rapeseed oil having 3%, 6% and 10% Citrem LR10. The addition of emulsifier show substantially the same release effect for the different concentrations of emulsifier i.e. 94-95% as compared with no coating.

Experiment 13: Coating of APET Cast Film Samples with MCT and PGE 308

TABLE 27
APET cast film samples without internal additive tested
with mayonnaise (80% fat content) after 3 days.

| Coating | Remaining | Improvement | Improvement |
|---|---|---|---|
| composition | product | compared to no | compared to oil |
| in wt % | in wt % | coating in % | coating in % |
| No coating | 8.4 | 0 | |
| 100% MCT | 1.8 | 78 | 0 |
| 3% PGE 308 in MCT | 1.5 | 83 | 17 |

As shown in Table 27 the release effect is observed using pure MCT as a coating. The release effect is only increased with 17% when adding 3% PGE 308 as an emulsifier. Comparing this with the results obtained with using 3% PGE 308 in rapeseed oil (Table 1; 89%) it seems that the emulsifier has a better effect in rapeseed oil than in MCT.

### SUMMARY PARAGRAPHS

The present invention will now be described by way of numbered paragraphs.
1. A polymer coating composition for coating a polymer surface consisting of an oil and an emulsifier, which forms a substantially homogenous solution.
2. The polymer coating composition according to paragraph 1, wherein said emulsifier is a glycerol or a polyglycerol ester.
3. The polymer coating composition according to any of the paragraphs 1 or 2, wherein the HLB-value of said emulsifier is above 3, like above 4, such as above 4.5, like above 5.
4. The polymer coating composition according to paragraph 3, wherein the HLB-value of the emulsifier is in the range of around 7 to around 12.
5. The polymer coating composition according to any of the preceding paragraphs, wherein said emulsifier is selected from diglycerol esters, polyglycerol fatty acid esters (PGEs), citric acid ester of mono-diglycerides (CITREM), diacetyl tartaric ester of mono-diglycerides (DATEM), monoglycerides, and mono-diglycerides of fatty acid esters.
6. The polymer coating composition according to any of the preceding paragraphs, wherein said oil is a vegetable oil.
7. The polymer coating composition according to paragraph 6, wherein said oil is rapeseed oil, soybean oil, high oleic sunflower oil or a mixture of one or more hereof.
8. The polymer coating composition according to any of the preceding paragraphs, wherein said emulsifier is present in an amount of 0.1-50 wt % of the coating.
9. The polymer coating composition according to any of the preceding paragraphs, wherein said emulsifier is present in an amount of 0.1-10 wt % of the coating.
10. The polymer coating composition according to any of the preceding paragraphs, wherein said emulsifier is present in an amount of 0.3-8 wt % of the coating.
11. The polymer coating composition according to any of the preceding paragraphs, wherein said emulsifier is present in an amount of 0.5-5 wt % of the coating.
12.A polymer surface being coated at least partly with a coating composition comprising at least one oil and at least one emulsifier, which forms a substantially homogenous solution.
13. The polymer surface according to paragraph 12, wherein said at least one emulsifier is a glycerol or a polyglycerol ester.
14. The polymer surface according to any of the paragraphs 12 or 13, wherein the HLB-value of said emulsifier is above 3, like above 4, such as above 4.5, like above 5.
15. The polymer surface according to paragraph 14, wherein the HLB-value is in the range of around 7 to around 12.
16. The polymer surface according to any of the paragraphs 12-15, wherein said at least one emulsifier is selected from diglycerol esters, polyglycerol fatty acid esters (PGEs), citric acid ester of mono-diglycerides (CITREM), diacetyl tartaric ester of mono-diglycerides (DATEM), monoglycerides, mono-diglycerides of fatty acid esters or a mixture of one or more hereof.
17. The polymer surface according to any of the paragraphs 12-16, wherein said oil is a vegetable oil.
18. The polymer surface according to paragraph 17, wherein said oil is rapeseed oil, soybean oil, high oleic sunflower oil or a mixture of one or more hereof.
19. The polymer surface according to any of the paragraphs 12-18, wherein said at least one emulsifier is present in an amount of 0.1-50 wt % of the coating.
20. The polymer surface according to any of the paragraphs 12-19, wherein said at least one emulsifier is present in an amount of 0.1-10 wt % of the coating.
21. The polymer surface according to any of the paragraphs 12-20, wherein said at least one emulsifier is present in an amount of 0.3-8 wt % of the coating.
22. The polymer surface according to any of the paragraphs 12-21, wherein said at least one emulsifier is present in an amount of 0.5-5 wt % of the coating.
23.A polymer surface being coated at least partly with a coating composition according to any of the paragraphs 1-11.
24. The polymer surface according to any of the paragraphs 12-23, wherein said polymer is a polyester.
25. The polymer surface according to paragraph 24, wherein said polymer is polypropylene (PP) or polyethylene terephthalate (PET).
26. The polymer surface according to any of the paragraphs 12-25, wherein said surface is part of a structure, said structure comprises an internal additive.
27. The polymer surface according to paragraph 26, wherein said internal additive is a distilled monoglyceride, a mono-diglyceride, a diglycerol ester or a mixture of one or more hereof.
28. The polymer surface according to any of the paragraphs 26-27, wherein said internal additive constitute between 0.1 and 5 wt % of said structure.
29. The polymer surface according to any of the paragraphs 26-28, wherein said internal additive constitute between 0.2 and 3 wt % of said structure.
30. The polymer surface according to any of the paragraphs 26-28, wherein said internal additive constitute between 0.3 and 2 wt % of said structure.
31. The polymer surface according to any of the paragraphs 26-28, wherein said internal additive constitute between 0.5 and 1.5 wt % of said structure.
32.A container for holding a fluid comprising at least one inner surface, said inner surface being, in use, in contact with said fluid where said inner surface is a polymer surface as described in any of the paragraphs 12-31.
33. The container according to paragraph 32, wherein said fluid is a food product.
34. The container according to paragraph 33, wherein said food product is mayonnaise or concentrated and non-concentrated fermented products.
35. The container according to paragraph 32, wherein said fluid is a non-food product.
36. The container according to paragraph 35, wherein said non-food product is a cream or lotion.
37. A method for forming a polymer coating composition for coating a polymer surface as described in any of the paragraphs 1-31 comprising the following steps:
   a. mixing at least one oil and at least one emulsifier to form a coating composition;
   b. contacting said polymer surface with said coating composition;
   c. optionally, allowing excess coating to flow off said surface.
38. A use of a polymer coating composition for improvement of release properties of a surface by coating at least partly said surface with said coating composition comprising at least one oil and at least one emulsifier, which forms a substantially homogenous solution.
39. The use of a polymer coating composition according to paragraph 38, wherein said at least one emulsifier is a glycerol or a polyglycerol ester.
40. The use according to any of the paragraphs 38 or 39, wherein the HLB-value of said emulsifier is above 3, like above 4, such as above 4.5, like above 5.
41. The use according to paragraph 40, wherein the HLB-value is in the range of around 7 to around 12.
42. The use of a polymer coating composition according to any of the paragraphs 38-41, wherein said at least one emulsifier is selected from diglycerol esters, polyglycerol fatty acid esters (PGEs), citric acid ester of diglycerol esters, citric acid ester of mono-diglycerides (CITREM), diacetyl tartaric ester of mono-diglycerides (DATEM), monoglycerides, mono-diglycerides of fatty acid esters or a mixture of one or more hereof.
43. The use of a polymer coating composition according to any of the paragraphs 38-42, wherein said oil is a vegetable oil.
44. The use of a polymer coating composition according to paragraph 43, wherein said oil is rapeseed oil, soybean oil, high oleic sunflower oil or a mixture of one or more hereof.
45. The use of a polymer coating composition according to any of the paragraphs 38-44, wherein said at least one emulsifier is present in an amount of 0.1-50 wt % of the coating.
46. The use of a polymer coating composition according to any of the paragraphs 38-45, wherein said at least one emulsifier is present in an amount of 0.1-10 wt % of the coating.
47. The use of a polymer coating composition according to any of the paragraphs 38-46, wherein said at least one emulsifier is present in an amount of 0.3-8 wt % of the coating.
48. The use of a polymer coating composition according to any of the paragraphs 38-47, wherein said at least one emulsifier is present in an amount of 0.5-5 wt % of the coating.
49. The use of a polymer coating composition according to any of the paragraphs 38-48, wherein said surface is an inner surface forming a cavity in a container, where said cavity is connected to the outside with an outlet opening.
50. The use of a polymer coating composition according to any of the paragraphs 38-49, wherein said polymer is a polyester.
51. The use of a polymer coating composition according to paragraph 50, wherein said polymer is polypropylene (PP) or polyethylene terephthalate (PET).
52. The use of a polymer coating composition according to any of the paragraphs 38-51, wherein said surface is part of a structure, said structure comprises an internal additive.
53. The use of a polymer coating composition according to paragraph 52, wherein said internal additive is a distilled monoglyceride, a mono-diglyceride, a diglycerol ester or a mixture of one or more hereof.
54. The use of a polymer coating composition according to any of the paragraphs 38-53, wherein said fluid is a food product.
55. The use of a polymer coating composition according to paragraph 54, wherein said food product is mayonnaise or concentrated and non-concentrated fermented products.
56. The use of a polymer coating composition according to any of the paragraphs 38-53, wherein said fluid is a non-food product.
57. The use of a polymer coating composition according to paragraph 56, wherein said non-food product is cream or lotion.

1. A polymer coating composition for coating a polymer surface consisting of an oil and an emulsifier, which forms a substantially homogenous solution.

2. The polymer coating composition according to claim 1, wherein said emulsifier is a glycerol or a polyglycerol ester.

3. The polymer coating composition according to claim 1, wherein the HLB-value of said emulsifier is above 3.

4. A polymer surface being coated at least partly with a coating composition comprising at least one oil and at least one emulsifier, which forms a substantially homogenous solution.

5. The polymer surface according to claim 4, wherein said at least one emulsifier is a glycerol or a polyglycerol ester.

6. The polymer surface according to claim 4, wherein the HLB-value of said emulsifier is above 3.

7. (canceled)

8. The polymer surface according to claim 4, wherein said polymer is a polyester.

9. The polymer surface according to claim 4, wherein said surface is part of a structure, and wherein said structure comprises an internal additive.

10. The polymer surface according to claim 9, wherein said internal additive is a distilled monoglyceride, a mono-diglyceride, a diglycerol ester or a mixture of one or more thereof.

11. The polymer surface according to claim 9, wherein said internal additive constitutes between 0.1 and 5 wt % of said structure.

12. A container for holding a fluid comprising at least one inner surface, said inner surface being, in use, in contact with said fluid wherein said inner surface is a polymer surface as described in claim 4.

13. The container according to claim 12, wherein said fluid is a food product.

14. A method for forming a polymer coating composition for coating a polymer surface as described in claim 1 the method comprising the following steps:
a. mixing at least one oil and at least one emulsifier to form a coating composition; and
b. contacting said polymer surface with said coating composition.

15. A method for improving release properties of a surface the method comprising coating at least partly said surface with a coating composition comprising at least one oil and at least one emulsifier, which forms a substantially homogenous solution.

16. The method according to claim 15, wherein said at least one emulsifier is a glycerol or a polyglycerol ester.

17. The method according to claim 15, wherein the HLB-value of said emulsifier is above 3.

18. The method of claim 15, wherein said surface is an inner surface forming a cavity in a container, wherein said cavity is connected to the outside with an outlet opening.

19. The method of claim 15, wherein said surface is part of a structure, and wherein said structure comprises an internal additive.

20. The method according to claim 19, wherein said internal additive is a distilled monoglyceride, a mono-diglyceride, a diglycerol ester or a mixture of one or more thereof.

21. (canceled)

22. (canceled)
